(19) United States
(12) Patent Application Publication
(10) Pub. No.: US 2026/0238355 A1
(43) Pub. Date: Aug. 13, 2026

(54) METHOD AND BASE STATION FOR DYNAMIC SS_ PBCH PROCESSING TO MITIGATE HIGH POWER NARROW-BAND INTERFERERS

(71) Applicant: INTERDIGITAL PATENT HOLDINGS, INC., Wilmington, DE (US)

(72) Inventors: Alpaslan Demir, East Meadow, NY (US); Joseph Murray, Schwenksville, PA (US); Sudhir Pattar, Mount Laurel, NJ (US); Philip Pietraski, Jericho, NY (US); Muhammad Fazili, Audubon, PA (US); Joe Huang, Montville, NJ (US); Tariq Elkourdi, Belleville, NJ (US); Patrick Cabrol, Bayshore, NY (US); Paul Russell, Lawrence, NJ (US)

(73) Assignee: INTERDIGITAL PATENT HOLDINGS, INC., Wilmington, DE (US)

(21) Appl. No.: 18/686,953

(22) PCT Filed: Aug. 26, 2022
(86) PCT No.: PCT/US2022/041723

§ 371 Date: Feb. 27, 2024

Related U.S. Application Data
(60) Provisional application No. 63/238,150, filed on Aug. 28, 2021.
(60) Provisional application No. 63/390,100, filed on Jul. 18, 2022.

(51) Int. Cl. H04B 15/02; H04B 17/345

(52) U.S. Cl. CPC H04B 15/02; H04B 17/345

(57) ABSTRACT

A system, device and method are provided for adapting transmission characteristics to mitigate negative impact on the wireless transmit receive unit (WTRU) when high-power, narrowband transmitters are propagating energy in narrow bands within the wider bands used by the WTRU to communicate in advanced communications networks. The system, device and method include detecting interference based on the presence of an interferer, determining the power spectral density (PSD) level from the interference, based on the PSD level exceeding a threshold, determining a synchronization signal burst (SSB) frequency location that mitigates the interference, and transmitting the determined SSB frequency location to at least one WTRU being served by the base station. After a preset period of time, in examples, the SSB frequency may be reverted back to an original SSB frequency. When the detected interference dissipates, in examples, the SSB frequency may be reverted back to an original SSB frequency

### CROSS-REFERENCE TO RELATED APPLICATIONS

This application is the U.S. National Stage, under 35 U.S.C. § 371, of International Application No. PCT/US2022/041723 filed Aug. 26, 2022, which claims the benefit of U.S. Provisional Application No. 63/390,100, filed Jul. 18, 2022, and U.S. Provisional Application No. 63/238,150, filed Aug. 28, 2021, the contents of which are incorporated herein by reference.

### BACKGROUND

To use advanced next generation networks implementing 5G NR standards including 3GPP R15 standard specifications, wireless transmit/receive units (WTRUs) such as mobile phones, laptops, etc., perform initial access procedures to attach to a cell of the network. Cell defining Synchronization Signal Bursts (SSBs) and related Master Information Block (MIB) and System Information block 1(SIB1) are key for the WTRUs to perform initial access procedures. Corrupted SSB bursts due to overlapping high-power narrowband interferer such as RADAR must be avoided in wireless communication systems especially in 5G cellular deployments. There is a need for networks, systems, methods and apparatus that can dynamically adapt network transmission characteristics responsive to channel conditions and interferer characteristics to mitigate the risk of negative impact on the network due to high power narrowband interference, as well as mitigate the impact of network transmissions on the high-power narrowband energy associated with the RADAR.

### SUMMARY

Disclosed and described herein are systems, methods and apparatus that can dynamically adapt their transmission characteristics to mitigate negative impact on the WTRU when high-power, narrowband transmitters are propagating energy in narrow bands within the wider bands used by the WTRU to communicate in advanced communications networks.

A system, device and method are provided for adapting transmission characteristics to mitigate negative impact on the WTRU when high-power, narrowband transmitters are propagating energy in narrow bands within the wider bands used by the WTRU to communicate in advanced communications networks. The system, device and method include detecting interference based on the presence of an interferer, determining the power spectral density (PSD) level from the interference, based on the PSD level exceeding a threshold, determining a synchronization signal burst (SSB) frequency location that mitigates the interference, and transmitting the determined SSB frequency location to at least one wireless transmit receive unit (WTRU) being served by the base station. The system, device and method may operate where the interferer is RADAR. The system, device and method may include the detecting interference includes determining the interference characteristics of the interferer. The system, device and method may further include comparing the determined interference characteristics of the interferer and the bandwidth of an existing SSB block frequency domain location. The system, device and method may include the detecting comprises measuring channel conditions including at least one of carrier frequency, bandwidth, periodicity, dwell time, and AoA. The system, device and method may include the detecting comprises receiving a channel condition measurement from at least one of a WTRU and gNB within the network. The system, device and method may include the threshold being based on characteristics where the interference affects operation. The system, device and method may include the determined SSB frequency is a different frequency, i.e., a lower frequency or a higher frequency. The system, device and method may further include, after a preset period of time, reverting the SSB frequency back to an original SSB frequency. The system, device and method may further include, when the detected interference dissipates, reverting the SSB frequency back to an original SSB frequency.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A illustrates the SSB structure;

FIG. 2B illustrates the SSB index location in the time domain;

FIG. 2C illustrates a cell defining frequency allocation;

FIG. 3A illustrates a mapping between Kssb (subcarrier offset), PDCCH-ConfigSIB1 (determining BW for PDCCH/SIB) for FR1;

FIG. 3B illustrates a mapping between Kssb and PDCCH-ConfiguSIB1 for FR2;

FIG. 4 illustrates a depiction of multiple SSBs in a carrier;

FIG. 5 illustrates an example in which a narrow band interferer is overlapping with an SSB block;

FIG. 6 illustrates a technique for moving an SSB location in a negative direction to mitigate interference;

FIG. 7 illustrates a method of moving the cell defining SSB frequency location in conjunction with the system of FIG. 6;

FIG. 8 illustrates a method of moving the cell defining SSB frequency location in conjunction with the system of FIG. 6;

FIG. 9 illustrates a method of moving the cell defining SSB frequency location in conjunction with the system of FIG. 6;

FIG. 10 illustrates a method of moving the cell defining SSB frequency location in conjunction with the system of FIG. 6;

FIG. 11 illustrates a method of moving the cell defining SSB frequency location in conjunction with the system of FIG. 6;

FIG. 12 illustrates a method of moving the cell defining SSB frequency location in conjunction with the system of FIG. 6;

FIG. 13 illustrates a technique for moving a cell defining SSB location in a positive direction to mitigate interference;

FIG. 14 illustrates a technique of defining multiple cell defining SSB to mitigate interference; and

FIG. 15 illustrates an example for a spatial solution to the interference for impacted SSB beams.

### DETAILED DESCRIPTION

To use advanced next generation networks implementing 5G NR standards including 3GPP R15 standard specifications, wireless transmit/receive units (WTRUs) such as mobile phones, laptops, etc., perform initial access procedures to attach to a cell of the network. Cell defining Synchronization Signal Bursts (SSBs) and related Master Information Block (MIB) and System Information block 1(SIB1) are key for the WTRUs to perform initial access procedures. Corrupted SSB bursts due to overlapping high-power narrowband interferer such as RADAR must be avoided in wireless communication systems especially in 5G cellular deployments. There is a need for networks, systems, methods and apparatus that can dynamically adapt network transmission characteristics responsive to channel conditions and interferer characteristics to mitigate the risk of negative impact on the network due to high power narrowband interference, as well as mitigate the impact of network transmissions on the high-power narrowband energy associated with the RADAR.

Disclosed and described herein are systems, methods and apparatus that can dynamically adapt their transmission characteristics to mitigate negative impact on the WTRU when high-power, narrowband transmitters are propagating energy in narrow bands within the wider bands used by the WTRU to communicate in advanced communications networks.

A system, device and method are provided for adapting transmission characteristics to mitigate negative impact on the WTRU when high-power, narrowband transmitters are propagating energy in narrow bands within the wider bands used by the WTRU to communicate in advanced communications networks. The system, device and method include detecting interference based on the presence of an interferer, determining the power spectral density (PSD) level from the interference, based on the PSD level exceeding a threshold, determining a synchronization signal burst (SSB) frequency location that mitigates the interference, and transmitting the determined SSB frequency location to at least one wireless transmit receive unit (WTRU) being served by the base station. The system, device and method may operate where the interferer is RADAR. The system, device and method may include the detecting interference includes determining the interference characteristics of the interferer. The system, device and method may further include comparing the determined interference characteristics of the interferer and the bandwidth of an existing SSB block frequency domain location. The system, device and method may include the detecting comprises measuring channel conditions including at least one of carrier frequency, bandwidth, periodicity, dwell time, and AoA. The system, device and method may include the detecting comprises receiving a channel condition measurement from at least one of a WTRU and gNB within the network. The system, device and method may include the threshold being based on characteristics where the interference affects operation. The system, device and method may include the determined SSB frequency is a different frequency, i.e., a lower frequency or a higher frequency. The system, device and method may further include, after a preset period of time, reverting the SSB frequency back to an original SSB frequency. The system, device and method may further include, when the detected interference dissipates, reverting the SSB frequency back to an original SSB frequency.

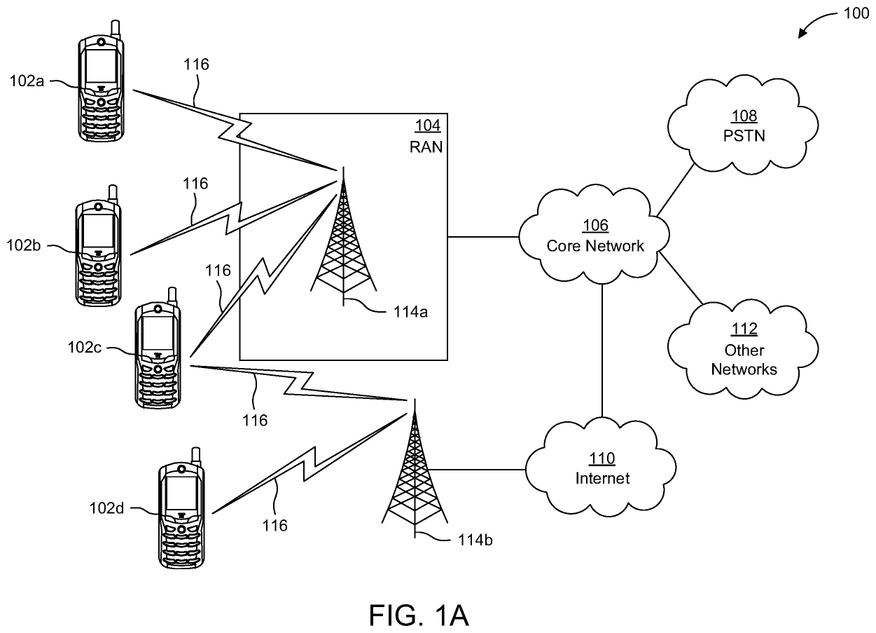

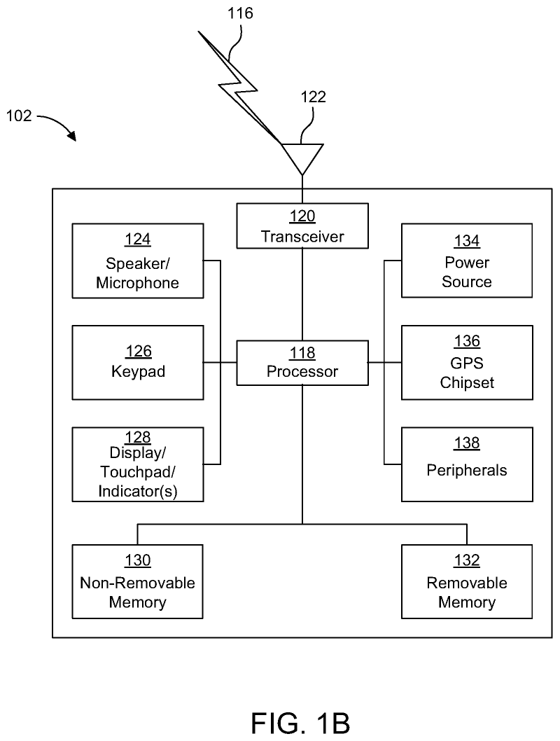

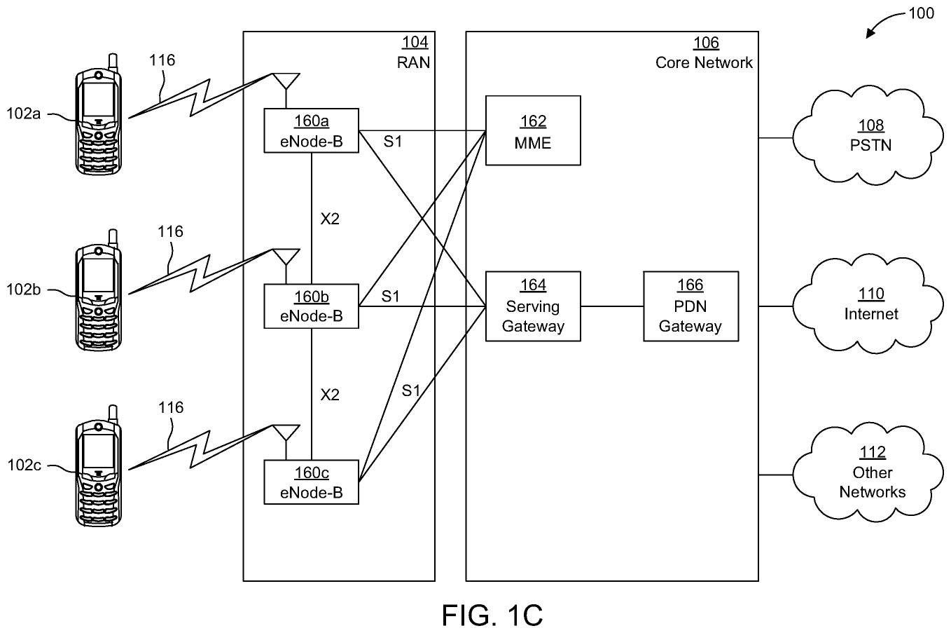

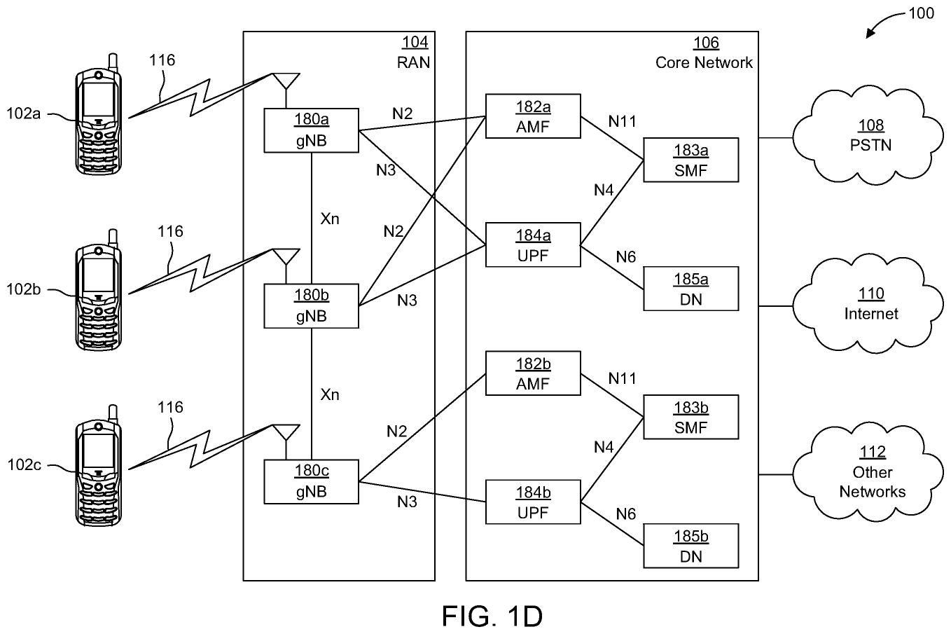

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCad), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Cell defining Synchronization Signal Bursts (SSBs) and related Master Information Block (MIB) and System Information Block 1 (SIB1) are key for the WTRUs to perform initial access procedures. Corrupted SSB bursts due to overlapping interference, such as a high-power narrowband interferer like RADAR in time and frequency domains need to be avoided in wireless communication systems.

When a narrow-band high power interferer interferes with the initial BWP including SSB transmission, system information exchange, Physical Random Access Channel (PRACH), and paging related signaling, the WTRUs may be unable to detect the synchronization signals and decode the system information, access the network, and decode the paging signals. When the interference overlaps with the initial BWP, not only the emerging WTRUs have difficulty accessing the network, but also the camped WTRUs may be unable to read System Information updates and paging messages, and perform RACH, if needed, over the initial BWP.

Existing prior arts are not agile and dynamic enough to meet future demands and requirements, as exemplified by the DoD spectrum sharing policy (i.e., DoD Instruction 4650.01). For example, the shared use of spectrum without harmful degradation or interference in a manner that provides current and future users sufficient regulatory protection, does not result in loss of access to the spectrum, and use of spectrum that allows mutual use, without degradation or harmful interference, in a manner that provides current and future users sufficient regulatory protection, that does not result in loss of access to the spectrum.

Generally, for a WTRU connect to a network cell, processing SSB bursts transmitted by cell node equipment occurs. A WTRU initial timing synchronization procedure may include a primary synchronization sequence (PSS) detection. The PSS detection identifies the symbol boundary. For example, the symbol timing offset=The PSS peak location−sequence length. MSP and FSP may be used to determine symbol timing offset. The WTRU initial timing synchronization procedure may include SSB index detection. The SSB index detection identifies the symbol offset with reference to the frame boundary. In examples, the SSB index is implicitly found by detecting Physical broadcast channel (PBCH) De-Modulation Reference Symbol (DMRS) sequence. The WTRU initial timing synchronization procedure may include PBCH Decoding. The PBCH Decoding enables frame timing to be determined by a WTRU based on the knowledge of PSS symbol timing offset, SSB index location in symbols and Half-Frame timing (0 or 5 ms, decoded from PBCH).

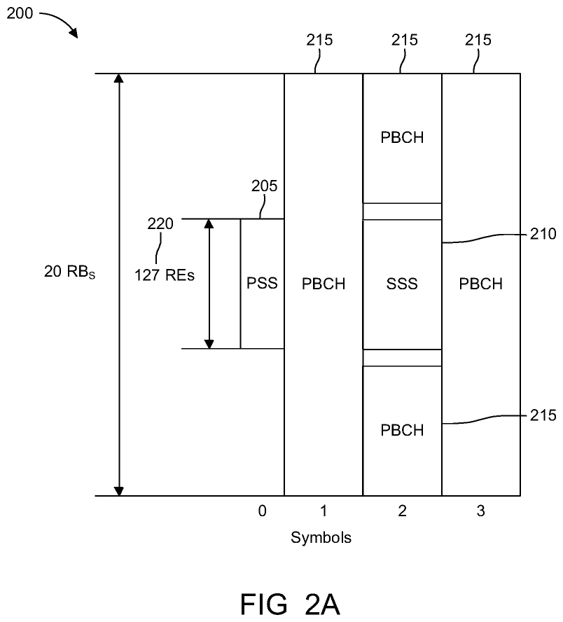

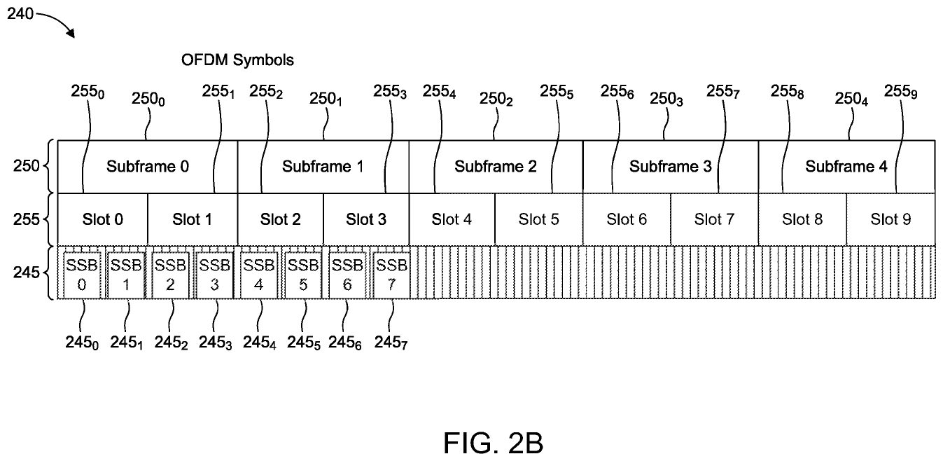

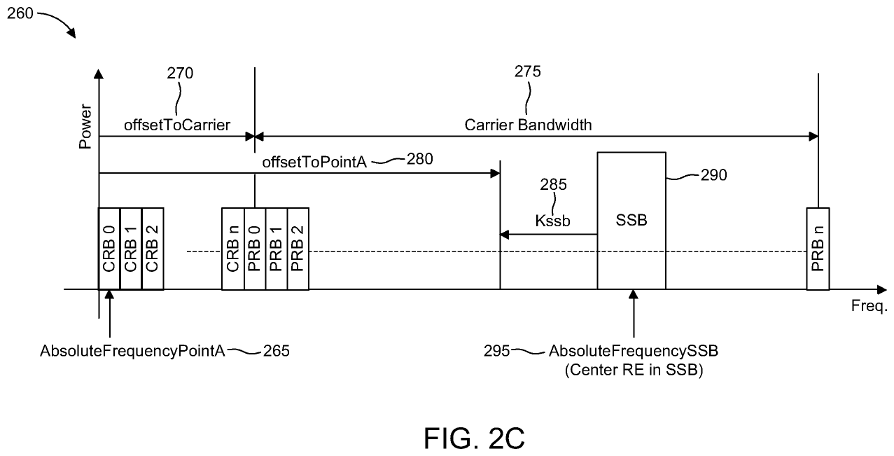

FIG. 2A illustrates the SSB structure 200. As illustrated in FIG. 2A, SSB structure 200 includes 20 Resource Blocks (RBs) where each RB is 12 Resource Elements (REs) 220 over a symbol duration, also known as a single subcarrier. SSB structure 200 includes a correspondence of the primary synchronization sequence (PSS) 205, PBCH 215 and secondary synchronization sequence (SSS) 210 to RE 220 as well as distribution of OFDM symbols across PSS 205, PBCH 215 and SSS 210. SSB structure 200 includes PSS 205 in symbol 0 and SSS 210 in symbol 2 occupying the same 127 REs 220 while being located one symbol apart. FIG. 2A illustrates the PBCH 215 spread over three consecutive symbols, i.e., symbols 1, 2, and 3.

FIG. 2B illustrates the SSB index location in the time domain. SSB index location as illustrated in the example of FIG. 2B is provided for carrier frequencies between 3 GHz and 6 GHz, where Subcarrier spacing (SCS)=30 kHz. Generally, the frame may be divided in two half frames. FIG. 2B illustrates a half frame 240. Half frame 240 is divided into a number of subframes 250 including subframe 0 250₀, subframe 1 250₁, subframe 2 250₂, subframe 3 250₃, and subframe 4 250₄, collectively referred to as subframes 250. Each of the subframes 250 is divided into two slots 255. For example, subframe 0 250₀ is divided into two slots slot 0 255₀ and slot 1 255₁, subframe 1 250₁ is divided into two slots slot 2 255₂ and slot 3 255₃, subframe 2 250₂ is divided into two slots slot 4 255₄ and slot 5 255₅, subframe 3 250₃ is divided into two slots slot 6 255₆ and slot 7 255₇, and subframe 4 250₄ is divided into two slots slot 8 255₆ and slot 9 255₉, collectively referred to as slots 255. A given slot 255 may include two SIBs 245. For example, slot 0 255₀ includes SIB 0 245₀ and SIB 1 245₁, slot 1 255₁ includes SIB 2 245₂ and SIB 3 245₃, slot 2 255₂ includes SIB 4 245₄ and SIB 5 245₅, and slot 3 255₃ includes SIB 6 245₆ and SIB 7 245₇, collectively referred to as SIBs 245. SSB indices 245 may be transmitted in predetermined symbols starting at Subframe 0 250₀ or Subframe 5 (not shown) to align the SSB burst transmissions in the first or the second half of the frame. The first and the fifth subframes are generally separated by 5 ms.

FIG. 2C illustrates a cell defining frequency allocation 260. Cell defining frequency allocation 260 include an AbsoluteFrequencyPointA 265 from which the plot of cell defining frequency allocation 260 increases with frequency and power. The offsetToCarrier 270 and carrier bandwidth 275 define the frequency allocation 260. Common resource blocks (CRB) may begin at AbsoluteFrequencyPointA 265 in increasing increments until CRBₙ that is included in the offsetToCarrier 270 with physical resources blocks (PRB) increase in increments until the end of the frequency allocation 260. An offsetToPointA 280 is provided from AbsoluteFrequencyPointA 265. From offsetToPointA 280 using Kssb 285, the SSB 290 may be located at an AbsoluteFrequnecySSB 295 using the center RE within the SSB.

In some examples, after WTRUs complete PSS, SSS detection and PBCH/MIB & SIB1 decoding, the network guides the WTRUs to determine the AbsoluteFrequencyPointA 265 (pointer to Common resource block 0 (CRB0) location in frequency domain). Once the WTRU detects the PSS, AbsoluteFrequencySSB 295 may be derived. After decoding PBCH and reading the MIB parameter ssb-SubcarrierOffset, Kssb 285 is known (for FR1, 4 LSB bits of Kssb value is determined by ssb-SubcarrierOffset in MIB and the MSB bit is provided via a bit within the PBCH Data; for FR2, the whole Kssb value can be determined via ssb-SubcarrierOffset in MIB). Kssb 285 provides information about the frequency offset between SSB and the common resource block (CRB) grid. In addition, MIB provides controlResourceSetZero and searchSpaceZero in Physical DL Control Channel (PDCCH)-ConfigSIB1 IE. The Control Resource Set (CORESET) #0 frequency location is determined by the controlResourceSetZero parameter (by pointing to the Offset parameter), while the searchSpaceZero parameter specifies the time-frequency multiplexing pattern between SSB and CORESET #0/PDSCH. Specifically, ssb-SubcarrierOffset, controlResourceSetZero, and searchSpaceZero are defined as below:

```
MIB ::= SEQUENCE {
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1 ,
  cellBarred ENUMERATED {barred, notBarred},
  intraFreqReselection ENUMERATED {allowed, notAllowed},
  spare BIT STRING (SIZE (1))
}
PDCCH-ConfigSIB1 ::= SEQUENCE {
  controlResourceSetZero ,
  searchSpaceZero
}
```

After decoding Type0-PDCCH for SIB1, the WTRU extracts the SIB1 parameter offsetToPointA 280 in cell defining frequency allocation 260.

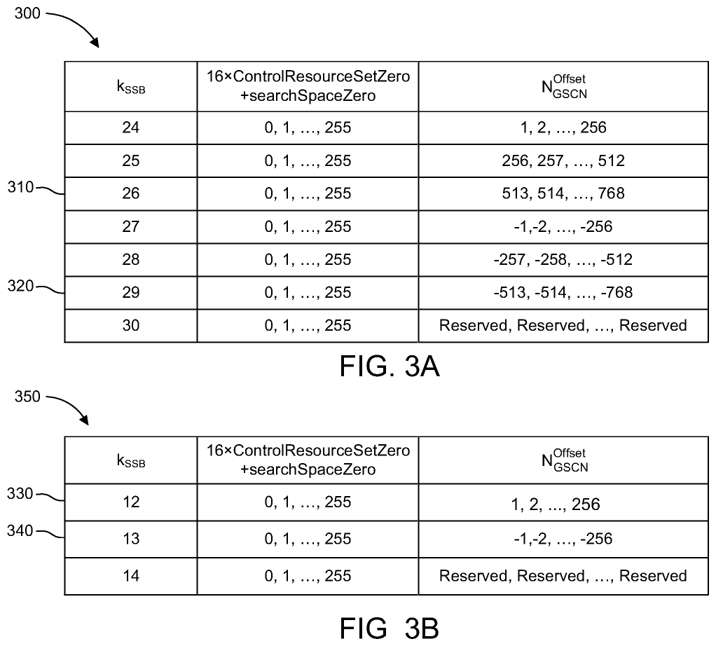

FIG. 3A illustrates a mapping 300 between Kssb (subcarrier offset), PDCCH-ConfigSIB1 (determining BW for PDCCH/SIB) for FR1 and FIG. 3B illustrates a mapping 350 between Kssb and pdcch-ConfiguSIB1 for FR2. FIG. 3A shows mapping between k_{SSB} (frequency domain offset), PDCCH-ConfigSIB1 (determining BW for PDCCH/SIB) and NGSCNOffset. A WTRU may monitor for presence of Type0-PDCCH for SIB1. SIB1 parameters may be extracted for initial access. The parameter that controls if an SSB is considered a cell defining SSB is the K_{SSB} parameter in MIB. K_{SSB} may provide the frequency domain offset between SSB and the common resource block grid in number of subcarriers (SCS=15 kHz). In some examples, the K_{SSB} field may indicate that the cell does not provide SIB1 and that there is no CORESET #0 configured in MIB.

According to an example, after decoding the MIB, a WTRU may perform the following procedure to decode SIB1 parameters. If Kssb≤23 for FR1 or Kssb≤11 for FR2, then the SIB1 may be transmitted in the same initial Bandwidth Part (BWP) where the SSB is detected.

If 24≤kSSB≤29 for FR1 or 12≤Kssb≤13 for FR2, then no SIB1 information exists, then the WTRU may find the SSB raster that has the SIB1 info. A target SSB raster position is given by Eq. 1:

$${N}_{GSCN}^{Reference} ( 1 + {N}_{GSCN}^{Offset} ) \qquad Eq . 1$$

Kssb=30 for FR1 and Kssb=14 for FR2 are reserved.

If Kssb=31 for FR1 or Kssb=15 for FR2, then there is no SSB having an associated Type0-PDCCH CSS set within a GSCN range as defined in Eq. 2:

$$[ {N}_{GSCN}^{Reference} - {N}_{GSCN}^{Start} , {N}_{GSCN}^{Reference} + {N}_{GSCN}^{End} ] \qquad Eq . 2$$

The subcarrier spacing used for the target SSB raster position in the above equation is 15 kHz for FR1 and 60 kHz for FR2 regardless of SSB subcarrier spacing. Accordingly, the maximum offset between a non-cell defining SSB and the cell defining SSB may be largest at Kssb=26 for FR1 (301) and Kssb=29 for FR1 (303), and at Kssb=12 for FR2 (330) and Kssb=13 for FR2 (340). The corresponding maximum offset between non-cell defining SSB and cell defining SSB is ±11.52 MHz for FR1 and ±15.36 MHz for FR2.

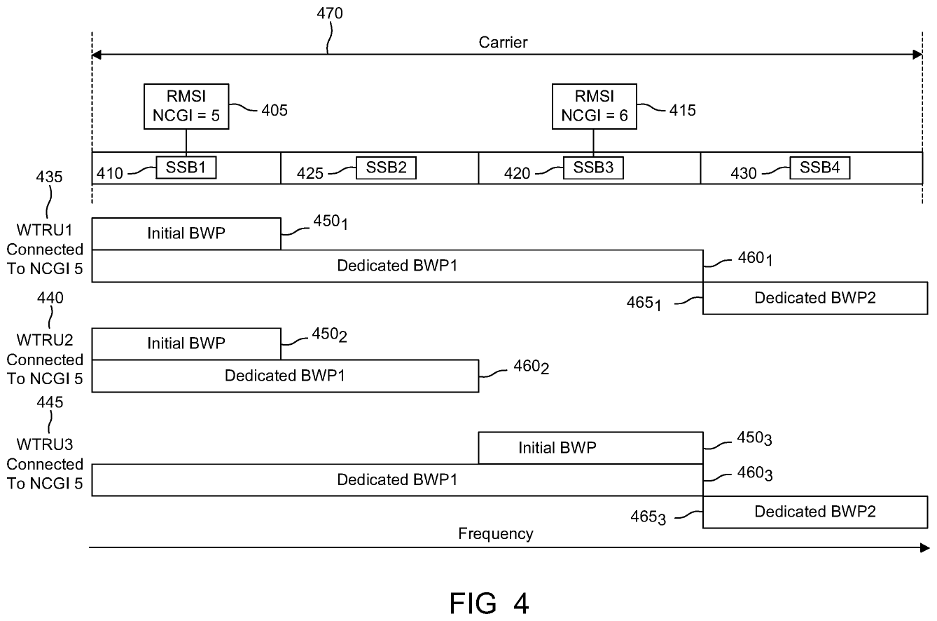

FIG. 4 illustrates a depiction 400 of multiple SSBs in a carrier. Specifically, FIG. 4 illustrates frequency domain (increasing moving to the right in depiction 400) placement of multiple SSBs 410, 420, 425, 430 within the carrier 470. For a WTRU in an RRC_CONNECTED state, the BWPs 450₁, 460₁, 465₁ as configured by a serving cell may overlap in the frequency domain with the BWPs 450₃, 460₃, 465₃ configured for other WTRUs for other cells within a carrier. BWPs 450₁, 460₁, 465₁ of WRTU 1 and BWPs 450₂, 460₂ of WRTU 2 are BWPs of different WTRUs within the same cell, i.e., Cell 5 with NCGI=5. Multiple SSBs may also be transmitted within the frequency span of a carrier used by the serving cell. From the WTRU perspective each serving cell is associated with at most a single SSB.

FIG. 4 illustrates a scenario in which there are multiple SSBs 410, 420, 425, 430 within a carrier 470, identifying two different cells 405, 415 (NCGI=5 405 (to be termed Cell 5) associated to SSB1 410, and NCGI=6 415 (to be termed Cell 6) associated to SSB3 420). Overlapping BWPs of Cell 5 450₁, 460₁, 465₁; 450₂, 460₂; and BWPs of Cell 6 450₃, 460₃, 465₃ are illustrated. RRM measurements may be performed by the WTRU on each of the available SSBs 410, 420, 425, 430, i.e., SSB1 410, SSB2 425, SSB3 420 and SSB4 430. There is a single cell defining SSB per cell, e.g., SSB1 410 for Cell 5 405 and SSB3 420 for Cell 6 415. The Cell defining SSB can only be in the initial BWP 450₁, 450₂ for Cell 5 and 450₃ for Cell 6. Each cell has only one initial BWP: 450₁ (configured to WTRU 1) and (configured to WTRU 2) 450₂ is the initial BWP for Cell 5, and 450₃ (configured to WTRU 3) is the initial BWP for Cell 6. Two different initial BWP IDs 450₁ and 450₂ in FIG. 4 are illustrated from WRTU perspective, while they are the same initial BWP from the cell perspective. Cell defining SSB is defined by the association with RMSI. Therefore, SSB1 410 and SSB3 420 are the cell-defining SSBs. Initial BWP is used for initial access. On the other hand, 460₁, 465₁ (configured to WTRU 1 from Cell 5), 460₂ (configured to WTRU 2 from Cell 5), 460₃, 465₃ (configured to WTRU 3 from Cell 6) are dedicated BWPs used for data transmission. Dedicated BWPs may be configured to a WTRU 435, 440, 445 after successful initial access via the initial BWP.

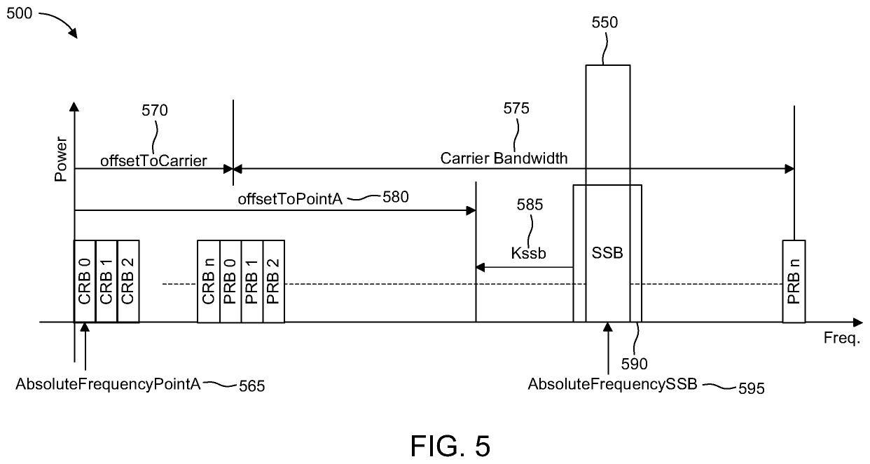

FIG. 5 illustrates an example 500 in which a narrow band interferer 550 is overlapping with an SSB block 590. Similar to the cell defining frequency allocation of FIG. 2C, example 500 includes a cell defining frequency allocation includes an AbsoluteFrequencyPointA 565 from which the plot of cell defining frequency allocation increases with frequency and power. The offsetToCarrier 570 and carrier bandwidth 575 define the frequency allocation. Common resource blocks (CRB) may begin at AbsoluteFrequencyPointA 565 in increasing increments until CRBₙ that is included in the offsetToCarrier 570 with primary resources blocks (PRB) increase in increments until the end of the frequency allocation. An offsetToPointA 580 is provided from AbsoluteFrequencyPointA 565. From offsetToPointA 580 using Kssb 585, the SSB 590 may be located at an AbsoluteFrequnecySSB 595 using the center RE within the SSB. In this example 500, there is an interferer 550 that interferes with the SSB 590. This interferer 550 is illustrated as being roughly centered on SSB 590, although as would be understood, this is only an example configuration as interference may occur with misalignments as well. Interferer 550 may be a narrowband high-power interferer such as RADAR. Interferer may be overlapping in some way (interfering) with cell defining SSB 590 block in frequency domain. Systems, apparatus and methods are disclosed herein by which a network dynamically reconfigures to mitigate the adverse effects that can occur in a scenario like this, thereby facilitating coexistence of advanced networks such as 5G NR and narrowband interferers such as RADAR.

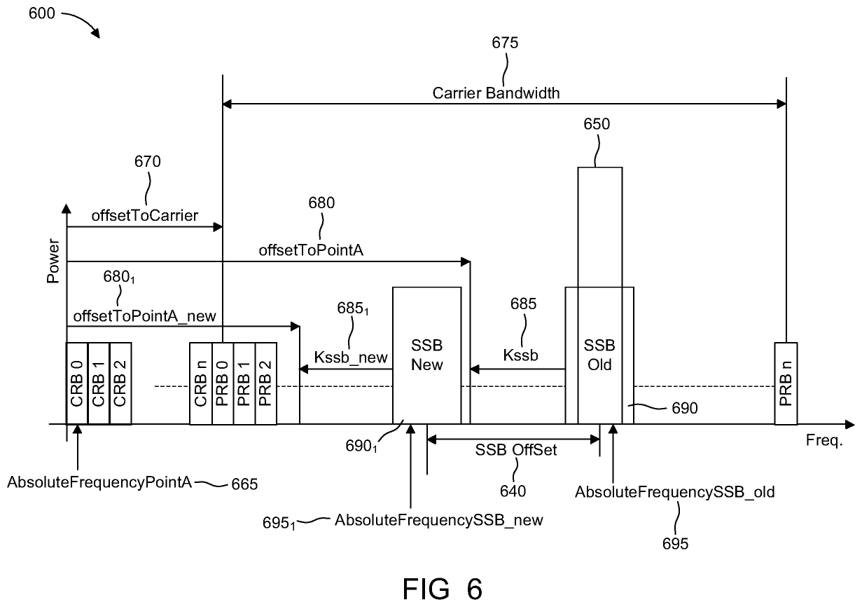

FIG. 6 illustrates a technique for moving an SSB location in a negative direction to mitigate interference. While FIG. 6 depicts the movement of the SSB location in a negative direction to mitigate the interference, the present description contemplates the movement of the SSB location in any direction to move away from the interference and the negative direction movement is only an example.

FIG. 6 illustrates an example 600 in which a narrow band interferer 650 is overlapping with an SSB block 690. Similar to the cell defining frequency allocation of FIG. 5, example 600 includes a cell defining frequency allocation includes an AbsoluteFrequencyPointA 665 from which the plot of cell defining frequency allocation increases with frequency and power. The offsetToCarrier 670 and carrier bandwidth 675 define the frequency allocation. Common resource blocks (CRB) may begin at AbsoluteFrequencyPointA 665 in increasing increments until CRBₙ that is included in the offsetToCarrier 670 with primary resources blocks (PRB) increase in increments until the end of the frequency allocation. An offsetToPointA 680 is provided from AbsoluteFrequencyPointA 665. From offsetToPointA 680 using Kssb 685, the SSB 690 may be located at an AbsoluteFrequnecySSB 695 using the center RE within the SSB. In this example 600, there is an interferer 650 that interferes with the SSB 690. This interferer 650 is illustrated as being roughly centered on SSB 690, although as would be understood, this is only an example configuration as interference may occur with misalignments as well. As described with respect to interferer 550 of FIG. 5, interferer 650 may be a narrowband high-power interferer such as RADAR. Interferer may be overlapping in some way (interfering) with cell defining SSB 690 block in frequency domain.

As illustrated in FIG. 6, systems, apparatus and methods are disclosed herein by which a network dynamically reconfigures to mitigate the adverse effects that can occur in a scenario like this, thereby facilitating coexistence of advanced networks such as 5G NR and narrowband interferers such as RADAR. A new offsetToPointA_new 680₁ and an SSB_new 690₁ located at AbsoluteFrequencySSB_new 695₁ using Kssb_new 685₁. As is illustrated in FIG. 6, SSB_new 690₁ is shifted from interferer 650 to mitigate interference with interferer 650. The cell defining SSB frequency location is moved to mitigate narrowband interference when the interference level triggers the event that the threshold passing detected. The process is triggered by narrowband high-power interference level from interferer 650 that passes the predefined threshold. The narrowband high-power interferer 650 triggering process may be achieved by either an external node that is independently determining characteristics of the interference, such as interference level, range, AoA or by observing the cellular domain protocol stack measurements that are provided by WTRUs or determined by the network nodes (i.e., gNBs). Once the interferer 650 presence is detected, the network creates a new cell defining SSB 690₁ that is in the carrier spectrum in a chosen location that the interference may not affect the SSB block processing for the emerging WTRUs for synchronization and initial access procedures, such as PSS, SSS detection, extracting MIB and SIB1 parameters, and performing RACH procedures. The WTRUs already camped on the cell may perform RACH procedures, if needed, and decode paging messages by using the new SSB 690₁.

In conjunction with the description of FIG. 6, methods for cellular network coexistence with a narrowband high-power interferer such as RADAR are disclosed and described herein. By the techniques disclosed herein the network takes responsive actions including but not limited to either shifting the impacted channels in frequency and/or time domains, or reducing the power level for the relevant beams to force to the WTRUs to move to other beams in the same cell or even to other cells to avoid the interference.

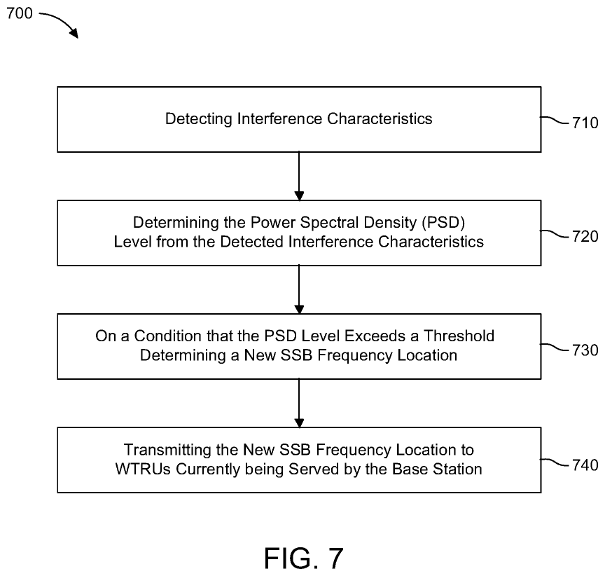

FIG. 7 illustrates a method 700 of moving the cell defining SSB frequency location in conjunction with the system of FIG. 6. Method 700 includes detecting interference characteristics of the interferer at 710. At 720, method 700 includes determining the power spectral density (PSD) level from the detected interference characteristics. On a condition that the PSD level exceeds a threshold, at 730, method 700 includes determining a new SSB frequency location. At 740, method 700 includes transmitting the new SSB frequency location to WTRUs currently being served by the base station.

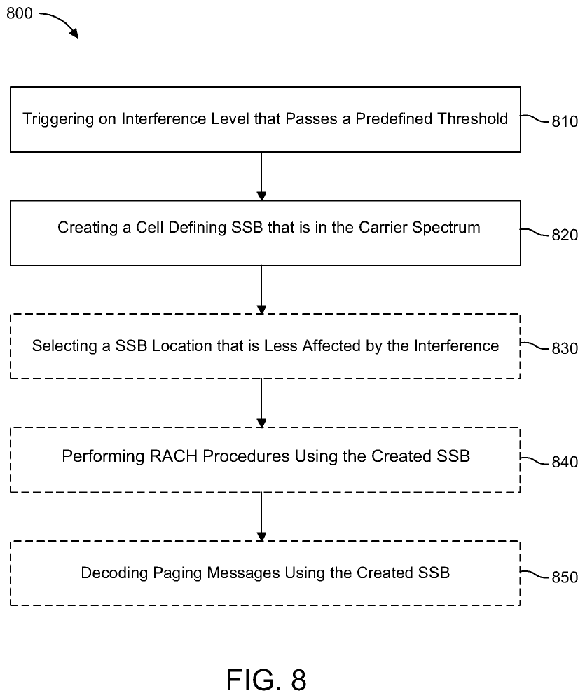

FIG. 8 illustrates a method 800 of moving the cell defining SSB frequency location in conjunction with the system of FIG. 6. Method 800 includes triggering on an interference level that passes a predefined threshold at 810. Method 800 includes creating a cell defining SSB that is in the carrier spectrum at 820. At 830, method 800 may include selecting an SSB frequency location that is less affected by the interference from the interferer identified by passing the threshold. At 840, method 800 may include performing RACH procedures using CORESET # and RACH resources associated with the created SSB. At 850, method 800 may include decoding paging messages using CORESET # and RACH resources associated with the created SSB.

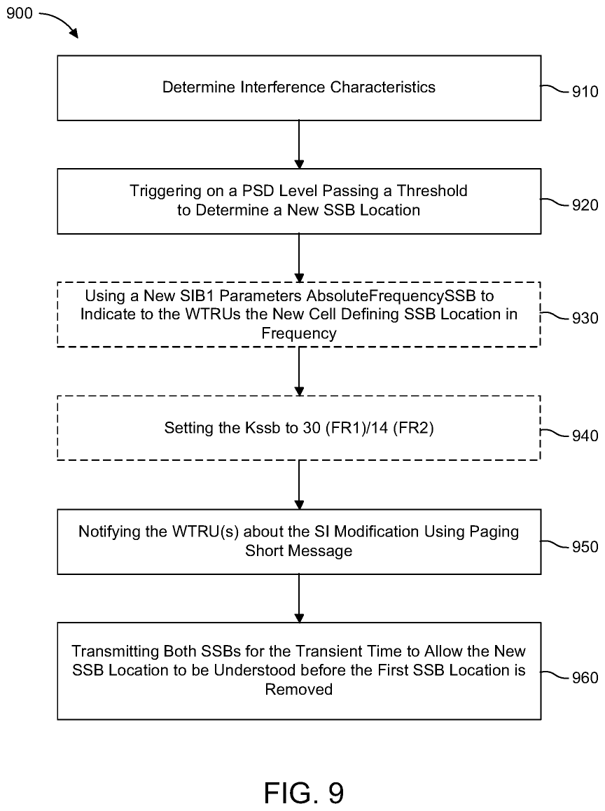

FIG. 9 illustrates a method 900 of moving the cell defining SSB frequency location in conjunction with the system of FIG. 6. Method 900 includes moving cell defining SSB frequency location to mitigate high power narrowband interference when the interference level triggers the event that the PSD threshold passing has been detected. Method 900 includes detecting interference characteristics of the interferer at 910. An external node to the network may determine the interferer characteristics, such as carrier frequency, bandwidth, periodicity, dwell time, AoA, and PSD. These measurements can also be determined within the wireless network by observing the measurements relevant to both WTRUs and the gNBs.

At 920, method 900 includes triggering on an interference characteristics passing a threshold to determine a new SSB location. For example, the PSD level passing a predefined threshold triggers an event.

At 930, method 900 may include using a new SIB1 parameter absoluteFrequencySSB to indicate to the WTRUs the new cell defining SSB location frequency. For example, upon the event triggering, the network determines the new SSB location in frequency, and uses a new SIB1 parameter absoluteFrequencySSB to indicate to WTRUs the new cell defining SSB location in frequency.

At 940, method 900 may include setting Kssb to 30 (FR1)/14 (FR2). At 950, method 900 includes notifying the WTRUs about the SI modification using paging short message. At 960, method 900 includes transmitting both SSBs for the transient time to allow the new SSB location to be understood before the first SSB location is removed.

In some examples, interferer characteristics such as periodicity, dwell time, power spectral density (PSD) and AoA are determined. In some examples, the characteristics are determined by a node or component operating independently or external to the network and communicated to the network from the external node. In other examples, the interference characteristics are determined by components of the network, i.e., the cellular system itself by measurements taken by devices operating in the network to provide cellular system related measurements.

In some examples, referring to FIG. 6, a cell defining SSB frequency location is moved from a first location taken at a time of interferer detection, to a second location upon detecting an interferer, where the second location avoids the narrowband interference to mitigate narrowband interference.

In examples of a method, the method begins when presence of an interferer is indicated. For example, the method can be triggered by detecting a narrowband high-power interference level that passes a predefined threshold. In some examples, a narrowband high-power interferer (e.g., RADAR) event-triggering process or method may be performed by either an external node that is independently determining RADAR characteristics such as interference level, range, AoA or by observing the cellular domain protocol stack measurements that are provided by WTRUs or determined by the network nodes (i.e., gNBs). In some examples, the external or independent node cooperates with one or more network nodes, e.g., gNBs, including for example the external node achieving synchronization with the network (i.e., gNB(s)). In some examples, the RADAR event triggering advantageously occurs while the RADAR-caused interference is still low enough to have negligible impact on the ongoing communications with the WTRUs, and detected early enough so that the system can take necessary actions ahead of time to avoid serious adverse consequences, e.g., complete network catastrophe, if the high-power RADAR interference went undetected. In that case, the RADAR interference may block the cell defining SSB signals altogether.

In some examples, once the RADAR presence is detected, the network creates a new cell defining SSB that is in the carrier spectrum in a chosen location such that the RADAR interference may not affect the SSB block processing for the emerging WTRUs for synchronization and initial access procedures such as PSS, SSS detection, extracting MIB and SIB1 parameters, and performing RACH procedures. In some examples, WTRUs already camped on to the cell may perform RACH procedures, as appropriate and may decode paging messages using the new SSB as well.

In some examples, WTRUs in RRC_IDLE or in RRC_INACTIVE monitor for a System Information (SI) change indication in its own paging occasion every DRX cycle. WTRUs in RRC_CONNECTED monitor for SI change indication in any paging occasion at least once per modification period if the WTRU is provided with a common search space on the active BWP to monitor paging.

A WTRU may receive indications about SI modifications using a Short Message transmitted in DCI format 1_0 with P-RNTI in the systemInfoModification bit. For Short Message reception in a paging occasion, the WTRU may monitor the PDCCH monitoring occasion(s) for paging. If a WTRU receives a Short Message with the systemInfoModification bit set to 1, the WTRU applies the SI acquisition procedure as known to those skilled in the art from the start of the next modification period. Updated SI message is broadcasted in the modification period following the one where SI change indication is transmitted. The modification period boundaries are defined by SFN values for which SFN mod m=0, where m is the number of radio frames comprising the modification period. The modification period is configured by the modificationPeriodCoeff parameter in the BCCH-Config IE and the defaultPagingCycle parameter in the PCCH-Config IE as described below. In addition, repetitions of SI change indication may occur within preceding modification period.

```
BCCH-Config ::= SEQUENCE {
  modificationPeriodCoeff ENUMERATED {n2, n4, n8, n16},
  ...
}
PCCH-Config ::= SEQUENCE {
  defaultPagingCycle PagingCycle,
  ...,
}
PagingCycle ::= ENUMERATED {rf32, rf64, rf128, rf256}
```

modificationPeriodCoeff means the actual modification period, expressed in number of radio frames m=modificationPeriodCoeff*defaultPagingCycle. n2 corresponds to value 2, n4 corresponds to value 4, and so on.

Upon the triggering of RADAR presence indication, the network may be informed with the RADAR parameters such as carrier location, interference bandwidth, AoA, PSD. Then, the network makes an assessment by comparing the RADAR carrier and bandwidth to the existing SSB block frequency domain location. In case the network decides that the RADAR interference may disrupt the SSB related channel detection and MIB and SIB1 decoding, the network may create a timer and inform all the WTRUs about the SI modification while configuring and immediately activating a new cell defining SSB location away from the RADAR interference in the carrier band. Some examples may be implemented using an overlap-timer such that the SSB location affected by the RADAR interference remains available long enough so that the camped WTRUs that only know the interference affected cell defining SSB time and frequency location have a chance to read the updated SI information at least once. During the transition period, the network may set the Kssb on the old SSB to 30 for FR1 and 14 for FR2 via the MIB parameter ssb-SubcarrierOffset along with the relevant PBCH bit (the latter is for FR1 only) to indicate that the current cell defining SSB is being removed, and both cell defining SSBs, the old and the new one, overlap until the overlap-timer expires. The absolute frequency location of the “target” cell defining SSB can be indicated in the FrequencyInfoDL-SIB IE using an additional field “absoluteFrequencySSB”. Specifically, the Kssb parameter (i.e., ssb-SubcarrierOffset) in the MIB and the newly introduced absoluteFrequencySSB in the FrequencyInfoDL-SIB IE (which in turn is part of the DownlinkConfigCommonSIB IE) are described as below:

```
MIB ::= SEQUENCE {
  systemFrameNumber BIT STRING (SIZE (6)),
  subCarrierSpacingCommon ENUMERATED {scs15or60, scs30or120}
  ssb-SubcarrierOffset INTEGER (0..15),
  dmrs-TypeA-Position ENuMERATED {pos2, pos3},
  pdcch-ConfigSIB1 PDCCH-ConfigSIB1,
  cellBarred ENUMERATED {barred, notBarred},
  intraFreqReselection ENUMERATED {allowed, notAllowed},
  spare BIT STRING (SIZE (1))
}
DownlinkConfigCommonSIB ::= SEQUENCE {
  frequencyInfoDL FrequencyInfoDL-SIB,
  initialDownlinkBWP BWP-DownlinkCommon,
  bcch-Config BCCH-Config,
  pcch-Config PCCH-Config,
  ...
}
FrequencyInfoDL-SIB ::= SEQUENCE {
  frequencyBandList MultiFrequencyBandListNR-SIB,
  offsetToPointA INTEGER (0..2199),
  scs-SpecificCarrierList SEQUENCE (SIZE (1..maxSCSs)) OF SCS-
SpecificCarrier
  absoluteFrequencySSB ARFCN-ValueNR
}
```

Alternatively, the frequency offset between and old and the new SSB may be provided to point to the new SSB frequency location.

Even in the presence of RADAR interference with RADAR bandwidth overlapping with the SSB/CORESET #0 bandwidth, it may still be possible for WTRUs to receive the SI modification notification. If the network or external sensors detect RADAR interference early enough, the impact on the NR downlink reception may be tolerable. In addition, interference from RADAR can be highly directional and highly dynamic since the RADAR beam can sweep in both the azimuth direction and the elevation direction. The NR downlink reception may be significantly impacted when the RADAR beam points directly to the NR system. When RADAR beam is pointing away, which may be the majority of the time, a WTRU may be able receive the paging short message.

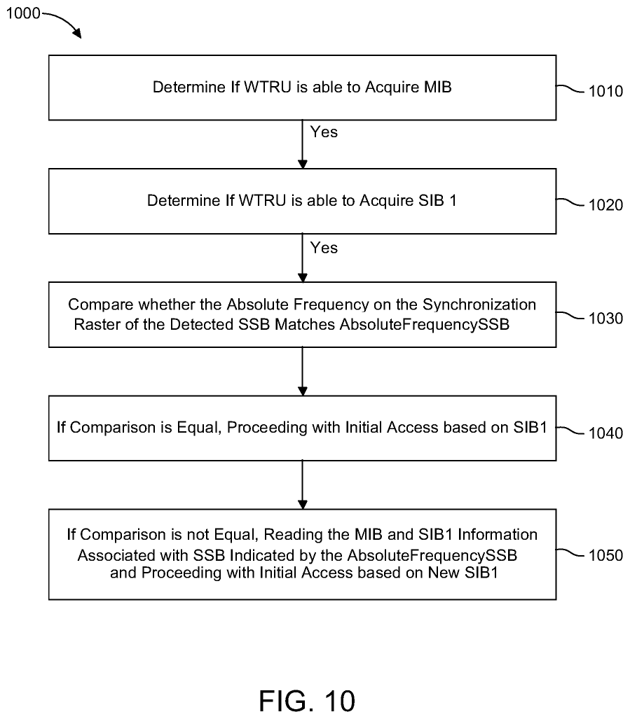

FIG. 10 illustrates a method 1000 of moving the cell defining SSB frequency location in conjunction with the system of FIG. 6. If the WTRU is able to acquire the MIB at 1010 and the SIB1 1020 despite the RADAR interference (this can be due to the SSB WTRU tries to acquire MIB/SIB1 which is not in the operating RADAR frequency bandwidth, or because at the time WTRU tries to acquire MIB/SIB1, the SSB/CORESET #0 is not subject to significant RADAR interference even though the SSB/CORESET #0 bandwidth still falls in the operating RADAR frequency bandwidth), and retrieves the SIB1 information, method 1000 may occur.

If Kssb=30 for FR1 or Kssb=14 for FR2 (cell defining SSB being removed), at 1030, method 1000 compares whether the absolute frequency on the synchronization raster of the currently detected SSB matches the absoluteFrequencySSB information in the FrequencyInfoDL-SIB IE. If the currently detected SSB absolute frequency matches the absoluteFrequencySSB, at 1040, method 1000 proceeds with initial access based on the RACH information provided by the SIB1. Method 1000, at 1050, includes reading the MIB and SIB1 information associated with the SSB indicated by the absoluteFrequencySSB. If the currently detected SSB absolute frequency does not match the absoluteFrequencySSB, at 1040, the initial access process proceeds based on the RACH information provided by the new SIB1 associated with the absoluteFrequencySSB indicated in the current SIB1, under the condition that the absolute frequency on the synchronization raster of the new SSB matches the absoluteFrequencySSB-indicated in the new SIB1. If there is still mismatch between new SSB absolute frequency and absoluteFrequencySSB indicated in the new SIB1, the WTRU may consider the cell as barred, and if the field intraFreqReselection in MIB message is set to “allowed”, the WTRU may select another cell on the same frequency if the selection criteria are fulfilled; and/or the WTRU shall exclude the barred cell as a candidate for cell selection/reselection for 300 seconds. If the condition Kssb=30 for FR1 or Kssb=14 for FR2 (cell defining SSB being removed) is not met, the WTRU ignores absoluteFrequencySSB and proceeds with the initial access process based on the RACH information provided by the SIB1.

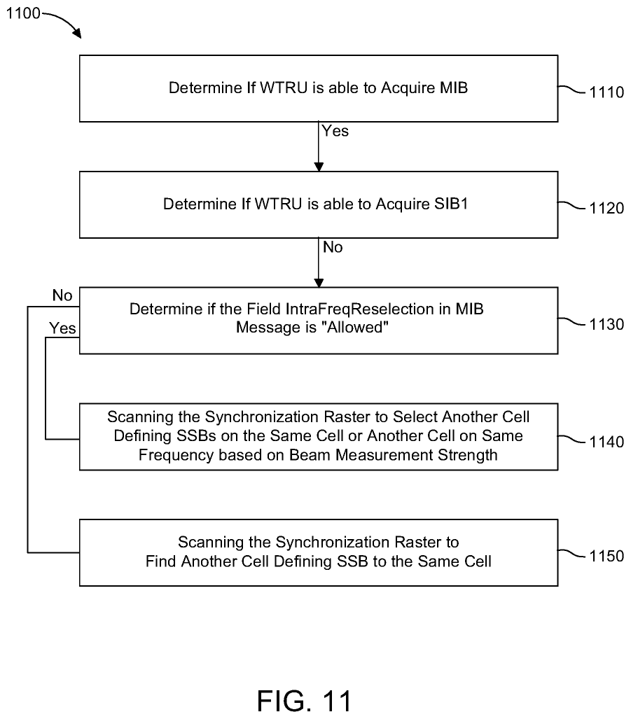

FIG. 11 illustrates a method 1100 of moving the cell defining SSB frequency location in conjunction with the system of FIG. 6. If the WTRU is able to acquire the MIB at 1110 but unable to acquire the SIB1 at 1120, if Kssb=30 for FR1 or Kssb=14 for FR2 (cell defining SSB being removed), and if the field intraFreqReselection in MIB message is set to “allowed” at 1130, method 1100 includes, at 1140, scanning the synchronization raster to select another cell defining SSBs on the same cell or another cell on the same frequency, whichever gives stronger SSB measurement results. If the field intraFreqReselection in MIB message is not set to “allowed” at 1130, method 1100, at 1150, includes scanning the synchronization raster to find another cell defining SSBs on the same cell only.

If the condition Kssb=30 for FR1 or Kssb=14 for FR2 (cell defining SSB being removed) is not met, method 1100 WTRU may consider the cell as barred and follow the procedures described in the prior art. If the field intraFreqReselection in MIB message is set to “allowed”, the WTRU may select another cell on the same frequency if re-selection criteria are fulfilled, and the WTRU shall exclude the barred cell as a candidate for cell selection/reselection for 300 seconds.

A camped WTRU may receive SIB1 as it should already know the subcarrier offset between SSB and common resource grid, while an emerging WTRU may not be able to receive SIB1 since Kssb has been set to 30 (FR1)/14 (FR2).

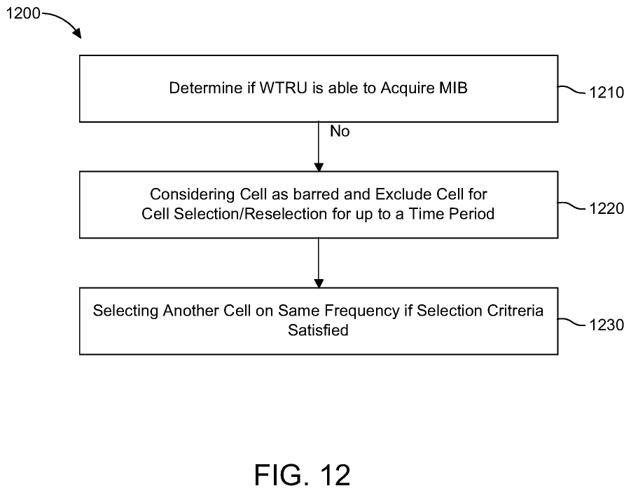

FIG. 12 illustrates a method 1200 of moving the cell defining SSB frequency location in conjunction with the system of FIG. 6. If a WTRU is unable to acquire the MIB at 1210, method 1200 includes considering the cell as barred and perform barring as if intraFreqReselection is set to allowed, and follow the procedures described in the art. The WTRU may exclude the barred cell as a candidate for cell selection/reselection for up to 300 seconds. At 1230, method 1200 includes selecting another cell on the same frequency if the selection criteria are fulfilled.

For RRC connected WTRUs, beam switching/recovery and mobility management may be performed on the latest SSB the WTRU retrieves the MIB and SIB1 system information from. The network may dynamically signal the RRC connected WTRUs to switch the SSB frequency location via dedicated RRC signaling. As shown in the message diagrams below, absoluteFrequencySSB in the FrequencyInfoDL IE (which is part of the DownlinkConfigCommon IE in the ServingCellConfigCommon IE) may be used to indicate the new SSB frequency location to the WTRU. Different signaling approaches, such as MAC-CE, may also be used to signal the SSB frequency switching.

```
FrequencyInfoDL ::= SEQUENCE {
  absoluteFrequencySSB ARFCN-ValueNR
OPTIONAL, -- Cond SpCellAdd
  frequencyBandList MultiFrequencyBandListNR,
  absolute FrequencyPointA ARFCN-ValueNR,
  scs-SpecificCarrierList SEQUENCE (SIZE (1..maxSCSs)) OF SCS-SpecificCarrier,
  ...
}
DownlinkConfigCommon ::= SEQUENCE {
  frequencyInfoDL FrequencyInfoDL OPTIONAL,
  -- Cond InterFreqHOAndServCellAdd
  initialDownlinkBWP BWP-DownlinkCommon OPTIONAL,
  -- Cond ServCellAdd
  ...
}
ServingCellConfigCommon ::= SEQUENCE {
  physCellId PhysCellId
OPTIONAL, -- Cond HOAndServCellAdd,
  downlinkConfigCommon DownlinkConfigCommon
OPTIONAL, -- Cond HOAndServCellAdd
  uplinkConfigCommon UplinkConfigCommon
OPTIONAL, -- Need M
  ...,
}
```

In other examples, the overlap-timer may be configured to implement one or more rules based on the RADAR interference level set by a measured RADAR interference PSD. If the PSD is greater than a predefined threshold, the overlap period for the new and the old cell defining SSB transmission can be shortened, for example, in some cases set to zero. If the RADAR interference is relatively low, the overlapping period can be set to a predefined maximum value. In another example, the overlapping period is set to be proportional to the RADAR PSD, e.g., directly proportional.

During the old and new SSB transmission overlapping period, the old SSB may inform the WTRUs that the associated SIB1 does not exist for further processing to get to SIB1 parameter extraction in initial access procedure. A WTRU cannot read RACH related parameters by using the old cell defining SSB. The Kssb in the K_{SSB} mapping technique illustrated in FIG. 3A may be used to indicate the location of the new cell defining SSB with all relevant access to extract the parameters in SIB1. For example, if the Kssb mapping entry 30 for the reserved field is used to indicate a positive frequency offset between the old and the new SSB, the mapping could be expanded to add an entry31 that can be used to indicate a corresponding negative frequency offset.

In some examples large positive and negative offset setting for Kssb with SCS of 30 kHz can be sufficient to avoid the high-power RADAR interferer when larger offsets are desired. For example, if it is measured that the RADAR interfere has 30 MHz bandwidth, the new SSB location is chosen to be bigger than 30 MHz to minimize the interference impact on the system.

The SSB offset as depicted in FIG. 6, while illustrated in the negative direction, may be in positive or negative direction depending on the initial BWP size and how the new cell defining SSB is or can be allocated in the carrier bandwidth. FIG. 6 depicts an example of a negative frequency offset. Upon removal, or reduction in the interference caused by the interferer, the SSB may be shifted back to the previous location, although such a return is not necessary. That is, the SSB may be shifted back when the interference is removed. Alternatively, the new SSB may be continued to be used indefinitely.

If the new cell defining SSB is later subject to interference, such as by an interferer including a RADAR signal, the current SSB may be moved. This movement may again be in either the negative direction as illustrated in FIG. 6, or may be moved in the positive direction with an offset. The offset may be the reverse of the offset that occurred in FIG. 6, although such a matching offset is not required.

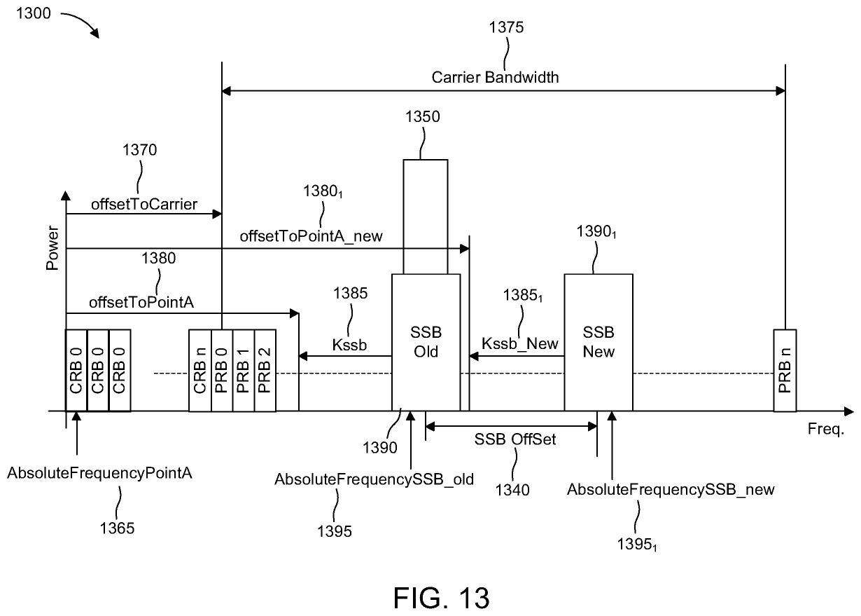

FIG. 13 illustrates a technique for moving a cell defining SSB location in a positive direction to mitigate interference. FIG. 13 illustrates an offset SSB in the positive direction with a positive offset. According to embodiments, the method can take the above-described actions in the reverse direction to move the cell defining SSB location to its original frequency location, for example in cases in which intercell interference was minimized as part of the initial network deployment scenario, or to a new location in the positive direction.

FIG. 13 illustrates an example 1300 in which a narrow band interferer 1350 is overlapping with an SSB block 1390. Similar to the cell defining frequency allocation of FIG. 6, example 1300 includes a cell defining frequency allocation includes an AbsoluteFrequencyPointA 1365 from which the plot of cell defining frequency allocation increases with frequency and power. The offsetToCarrier 1370 and carrier bandwidth 1375 define the frequency allocation. Common resource blocks (CRB) may begin at AbsoluteFrequencyPointA 1365 in increasing increments until CRBₙ that is included in the offsetToCarrier 1370 with physical resources blocks (PRB) increase in increments until the end of the frequency allocation. An offsetToPointA 1380 is provided from AbsoluteFrequencyPointA 1365. From offsetToPointA 1380 using Kssb 1385, the SSB 1390 may be located at an AbsoluteFrequnecySSB 1395 using the center RE within the SSB. In this example 1300, there is an interferer 1350 that interferes with the SSB 1390. This interferer 1350 is illustrated as being roughly centered on SSB 1390, although as would be understood, this is only an example configuration as interference may occur with misalignments as well. As described with respect to interferer 650 of FIG. 6, interferer 1350 may be a narrowband high-power interferer such as RADAR. Interferer may be overlapping in some way (interfering) with cell defining SSB 1390 block in frequency domain.

As illustrated in FIG. 13, systems, apparatus and methods are disclosed herein by which a network dynamically reconfigures to mitigate the adverse effects that can occur in a scenario like this, thereby facilitating coexistence of advanced networks such as 5G NR and narrowband interferers such as RADAR. A new offsetTo PointA_new 1380₁ and an SSB_new 1390₁ located at AbsoluteFrequencySSB_new 1395₁ using Kssb_new 1385₁. As is illustrated in FIG. 13, SSB_new 1390₁ is shifted from interferer 1350 to mitigate interference with interferer 1350. In FIG. 13 the shift is in the positive direction and may move the SSB 1390₁ back to the original location of SSB 690 in FIG. 6 or to another predefined or currently determined position.

As described with respect to FIG. 6, the cell defining SSB frequency location is moved to mitigate narrowband interference when the interference level triggers the event that the threshold passing detected. The process is triggered by narrowband high-power interference level from interferer 1350 that passes the predefined threshold. The narrowband high-power interferer 1350 triggering process may be achieved by either an external node that is independently determining characteristics of the interference, such as interference level, range, AoA or by observing the cellular domain protocol stack measurements that are provided by WTRUs or determined by the network nodes (i.e., gNBs). Once the interferer 1350 presence is detected, the network creates a new cell defining SSB 1390₁ that is in the carrier spectrum in a chosen location that the interference may not affect the SSB block processing for the emerging WTRUs for synchronization and initial access procedures, such as PSS, SSS detection, extracting MIB and SIB1 parameters, and performing RACH procedures. WTRUs already camped on the cell may need to be notified by SI regarding the SSB change and then find the new SSB frequency location by reading the AbsoluteFrequencySSB parameter introduced in the original SIB1 before using the new SSB.

In some examples, including those described in FIGS. 6 and 13, a plurality of cell-defining SSB candidates are selected. The cell defining SSB is very important for the emerging WTRUs to access to the network as well as for already existing WTRUs in the network to monitor and extract the SI information updates and related paging messages. Examples in which only one cell defining SSB alternative is selected may not adequately mitigate the likelihood of adverse impact such as total system failure for both the emerging and already attached WTRUs, where a high-power narrow band interferer such as RADAR overlaps in time and frequency domains with that SSB transmissions.

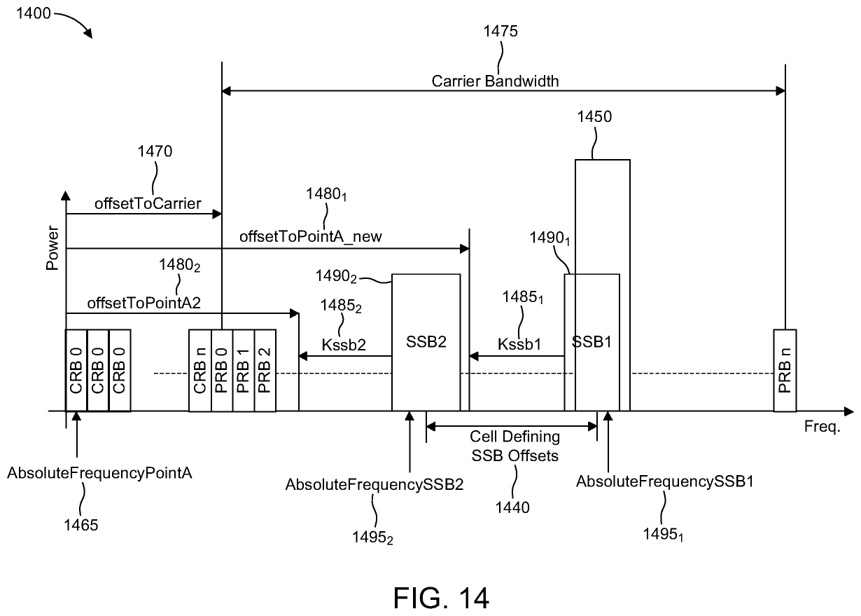

FIG. 14 illustrates alternative example 1400 with two cell defining SSB locations are selected to mitigate the impact of an interferer. While this example illustrates the use of two cell defining SSB locations, more than two simultaneous cell defining SSBs may be selected in various frequency locations, as two is used herein for a clarity of understanding. The use of two or more cell defining SSB location may increase the probability of initial access for the emerging WTRUs and connectivity for the existing WTRUs in the network. Once an emerging WTRU detects and decodes one of the cell defining SSBs, the WTRU extracts the necessary information relevant to other cell defining SSB locations and their system parameters. In some examples, the SIB1 may be expanded with a field to indicate cell defining SSB offsets relative to the current SSB block. For example, if the emerging WTRU gets into the system via SSB1 detection, and SSB1 related MIB and SIB1 reading, the WTRU may extract the cell defining SSB offset to SSB2 frequency location in the resource grid as described herein. Similarly, if a WTRU detects the SSB2 first and goes through the related MIB and SIB1 parameter extraction, the WTRU is informed about SIB1 location in the resource grid by using the cell defining SSB offset in reference to SSB2.

FIG. 14 illustrates a technique for selecting two cell defining SSB locations in order to mitigate the impact of an interferer interfering with one location. FIG. 14 illustrates an example 1400 in which a narrow band interferer 1450 is overlapping with an SSB block 1490₁. Similar to the cell defining frequency allocation of FIGS. 6 and 13, example 1400 includes a cell defining frequency allocation includes an AbsoluteFrequencyPointA 1465 from which the plot of cell defining frequency allocation increases with frequency and power. The offsetToCarrier 1470 and carrier bandwidth 1475 define the frequency allocation. Common resource blocks (CRB) may begin at AbsoluteFrequencyPointA 1465 in increasing increments until CRBₙ that is included in the offsetToCarrier 1470 with physical resources blocks (PRB) increase in increments until the end of the frequency allocation. An offsetToPointA1 1480₁ and an offsetToPointA2 1480₂ are provided from AbsoluteFrequencyPointA 1465. From offsetToPointA1 1480₁ using Kssb1 1485₁, the SSB1 1490₁ may be located at an AbsoluteFrequnecySSB 1495₁ using the center RE within the SSB. From offsetToPointA2 1480₂ using Kssb2 1485₂, the SSB2 1490₂ may be located at an AbsoluteFrequnecySSB 1495₂ using the center RE within the SSB.

In this example 1400, there is an interferer 1450 that interferes with the SSB1 1390₁. This interferer 1450 is illustrated as being roughly centered on SSB1 1490₁, although as would be understood, this is only an example configuration as interference may occur with misalignments as well. As described with respect to interferer 650 of FIG. 6, interferer 1450 may be a narrowband high-power interferer such as RADAR. Interferer may be overlapping in some way (interfering) with cell defining SSB1 1490₁ block in frequency domain. In such a configuration, and slightly different from that described with respect to FIG. 6 where a new SSB is defined, in order to avoid the interference with respect to interferer 1450, SSB2 1490₂ is readily available. In the case of two cell defining SSBs, both SSB1 1490₁ and SSB2 1490₂ are simultaneously in use. Under normal operating conditions, Some WTRUs may synchronize with the cell via SSB1 1490₁ during initial synchronization raster search and others SSB2 1490₂. In the event of SSB1 1490₁ being impacted by interference, the system may shut down SSB1 1490₁. As a result, all WTRUs may need to go through SSB2 1490₂.

As illustrated in FIG. 14, systems, apparatus and methods are disclosed herein by which a network dynamically reconfigures to mitigate the adverse effects that can occur in a scenario like this, thereby facilitating coexistence of advanced networks such as 5G NR and narrowband interferers such as RADAR. The pre-defined SSB2 1490₂ may be used to mitigate the interference from interferer 1450.

As noted above, FIG. 14 illustrates a technique of defining multiple SSB to mitigate RADAR interference. In some implementations multiple initial BWPs are used to enable simultaneous multi cell defining SSB transmissions. Multiple initial BWPs can be deployed such that if the narrowband interferer such as RADAR is present, at least one of the initial BWP can be available to guarantee emerging WTRUs to perform initial access and guaranteed connectivity for the existing WTRUs in the system. It is assumed that each initial BWP has its own cell defining SSB.

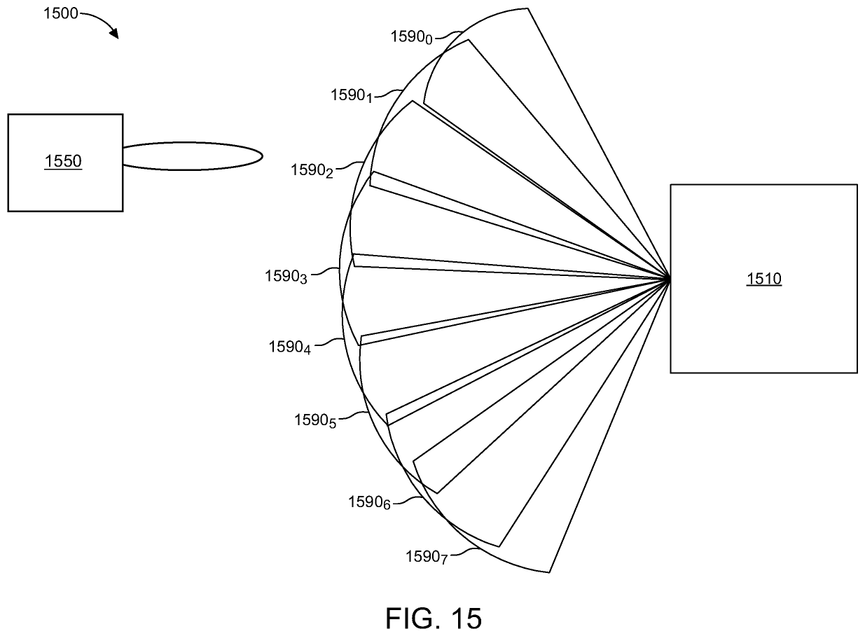

FIG. 15 illustrates an example 1500 for a spatial solution to the interference for impacted SSB beams. As illustrated in FIG. 15, a gNB 1510 may include a number of SSB locations 1590. The SSB locations 1590 include, in the illustration of FIG. 15, SSB location 0 1590₀, SSB location 1 1590₁, SSB location 2 1590₂, SSB location 3 1590₃, SSB location 4 1590₄, SSB location 5 1590₅, SSB location 6 1590₆, SSB location 7 1590₇ (collectively referred to as SSB locations 1590). The interferer 1550 may radiate energy in the direction of SSB 1590 beams radiated by a gNB 1510 (node) of a network. As illustrated the interferer 1550 may affect SSB 1590₂ and in response to the interference of interferer 1550, SSB 1509₂ may be unused, reduced in power, or even shutdown. Similarly, interferer 1550, as illustrated may also affect one or more SSBs 1590 including, for example SSB 1509₁ and SSB 1590₃—the neighbors of affected SSB 1590₂. In this example, one of SSB 1590₁ and 1590₃ may, in response to the interference of interferer 1550, be unused, reduced in power, or even shutdown

In some examples a method to mitigate the impact of interferers 1550 such as high-power narrowband interferers includes actions of gradually reducing transmit power in potentially or actually affected SSB beam 1590 indices. For example, when a narrowband high-power interferer 1550 such as RADAR is detected and the AoA and PSD levels of the interferer 1550 are also provided, the network 1510 may identify the affected SSB beam 1590 indices that are overlapping with the interferer 1550 by comparing the AoA and the SSB beam 1590 index directions. In some examples, the network 1510 may have prior knowledge of the SSB beam 1590 index directions and orientation, e.g., by acquiring and storing this information when the network 1510 is first implemented or initially set up. In some examples, antenna orientation is assumed to be fixed, e.g., as per a deployment scenario. In such examples, if the AoA of an interferer 1550 is known or understood, the corresponding SSB index 1590 to that AoA may be identified. Such identification is performed as part of a method according to examples.

Some example include detection of an interferer 1550. Upon the detection of the interferer 1550 and the identified SSB indices 1590 that are overlapping with the interferer's AoA, the network 1510 gradually reduces the transmit power level for the affected SSB indices 1590 such that the WTRUs (not shown) that are connected to the network via the affected SSB indices 1590 are forced to select other SSB indices 1590 that are not affected by the interferer 1550. The process can lead to a new beam selection procedure or even to initiate a handover.

In some examples, while reducing the interferer impacted SSB 1590 the network 1510, or one or more components thereof, indicates the reference power level variations. For example, if the amount of power reduction in the interference affected SSB beams 1590 are amounting to more than a predefined threshold (e.g. 3 dB), the network 1510 may inform the WTRUs by using SIB1 about the transmit power level changed. The gradual power reduction in interference affected SSB indices 1590 may be set to a delta offset (e.g. 0.5 dB per SSB transmission) such that the impact to the connected WTRUs are minimized. A sudden removal of an SSB beam 1590 within the coverage area can cause call drops and out of synchronization issues for the connected WTRUs in the network 1510.

FIG. 15 illustrates a scenario in which an interferer 1550 radiates energy in a direction of SSB beams 1590 radiated by a gNB (node) 1510 of a network. The interferer 1550 as illustrated in FIG. 15 directly impacts the SSB2 beam 1590₂ coverage. In this example, it may be desirable to force the emerging WTRUs to find and select other SSB indices 1590 and possibly find other cells. Existing WTRUs also move to another beam or cell as well, in order to minimize network interference to the SSB2 1590₂ receiver. The network may gradually reduce the SSB2 1590₂ transmit power.

In some examples, a second event may occur when the interferer 1550 is no longer affecting the network 1510. When the occurrence of such an event is detected, or upon receiving some other indication that the interferer 1550 is no longer affecting the network 1510 (i.e., the interferer is not present any longer), the transmit power levels related to the SSB beam indices 1590 may be restored to their original settings, i.e., the settings in place before the arrival of the interferer 1550.

In some examples, the network 1510 dynamically responds to changes in interferer 1550 characteristics, or changes in interferer 1550 or related channel conditions. For example, in the case where the narrowband interferer 1550 has periodic transmissions, its time domain characteristics such as transmission period and dwell time may be determined. The network 1510 may schedule the important physical channels such as SSB blocks based on the determination so as to avoid the time domain overlap with the interferer 1550.

In some examples, the Synchronization and Broadcast Channel combination (SS_PBCH) burst periods may be set to one of the entries among {5, 10, 20, 40, 80, and 160 ms} to meet 3GPP standards. The network 1510 can change the SSB burst location in time so as not to overlap with the interferer 1550 without changing the SSB burst periodicity, by using the half frame timing update. The SSB bursts may be transmitted either at the beginning of the first or the second half of the frame. The MIB reading identifies whether the detected SSB bursts were in the first or the second half the frame so that the WTRUs may determine full initial downlink synchronization.

In some examples, in combination with time-shifting by half frame (i.e., 5 ms), the network 1510 may use a different SSB burst periodicity to avoid the interferer. For example, if the interferer 1550 is present at every 100 ms with a dwell time of 2 ms, the network 1510 may alter the SSB burst period to 40 ms and transmit the SSB bursts until the least common factor in time is observed, since the periodic SSB burst and the periodic interferer eventually overlaps. The network 1510 may modify the SSB burst transmissions by either using the half frame timing shift or SSB burst periodicity update to avoid the next overlap occurrence. The time domain interferer avoidance process continues as long as the interferer 1550 is present with measurable characteristics (e.g., periodicity and dwell time).

When the network takes necessary actions to avoid a periodic high-power narrowband interferer 1550, the beam failure mechanism may be prevented from triggering by the connected WTRUs. The network may modify the system parameters such that the WTRUs do not declare beam failure or out of synchronization events during the interference. In one example, the beam failure count is increased in the presence of the interferer 1550. The increased SSB burst periodicity cannot adversely cause beam failure triggering.

If the interference from interferer 1550 is no longer present, the network applies settings for SSB burst periods favourable for the WTRUs to expedite recovery within the network. After a predefined period passes or the observed number of PRACH attempts are settled, the network can go back to defaults parameters optimized for deployment scenario. Further details of embodiments are disclosed and described below.

As discussed above, responsive to interference events or triggers, a network management component can change cell defining SSB frequency location (in FIGS. 6 and 13, for example) so as to mitigate high power narrowband interference, for example when the interference level triggers the event that the PSD threshold passing has been detected. In some embodiments, an external node to the network can determine the interferer characteristics such as carrier frequency, bandwidth, periodicity, dwell time, AoA, and PSD. In some examples, the measurements may be determined within the wireless network by observing the measurements relevant to both WTRUs and the gNBs.

The PSD level passing a predefined threshold triggers an event. Upon the event triggering, the network determines the new SSB location in frequency, and uses a new SIB1 parameter absoluteFrequencySSB to indicate to all WTRUs the new cell defining SSB location in frequency and sets the Kssb to 30 (FR1)/14 (FR2). The network notifies the WTRU about the SI modification using a paging short message. The network transmits both SSBs for the transient time so that the WTRUs have at least a chance to understand about the new SSB location before the first SSB location is removed altogether.

If the WTRU is able to acquire the MIB and SIB1 despite the RADAR interference, and if Kssb=30 for FR1 or Kssb=14 for FR2 (cell defining SSB being removed), the WTRU compares whether the absolute frequency on the synchronization raster of the currently detected SSB matches the absoluteFrequencySSB. If the currently detected SSB absolute frequency matches the absoluteFrequencySSB, the WTRU proceeds with the initial access process based on the RACH information provided by the SIB1. If a mismatch is detected, the WTRU moves on to read the MIB and SIB1 information associated with the SSB indicated by the absoluteFrequencySSB. The WTRU then proceeds with the initial access process based on the RACH information provided by the new SIB1. If the condition Kssb=30 for FR1 or Kssb=14 for FR2 (cell defining SSB being removed) is not met, the WTRU ignores absoluteFrequencySSB and proceeds with the initial access process based on the RACH information provided by the SIB1.

If a WTRU is able to acquire the MIB but unable to acquire the SIB1, and if Kssb=30 for FR1 or Kssb=14 for FR2 (cell defining SSB being removed), and if the field intraFreqReselection in MIB message is set to “allowed”, the WTRU scans the synchronization raster to select another cell defining SSBs on the same cell or another cell on the same frequency, whichever gives stronger beam measurement results. Otherwise, the WTRU scans the synchronization raster to find another cell defining SSBs on the same cell only. If the condition Kssb=30 for FR1 or Kssb=14 for FR2 (cell defining SSB being removed) is not met, the WTRU shall consider the cell as barred and follow the procedures described the current art. If the field intraFreqReselection in MIB message is set to “allowed”, the WTRU may select another cell on the same frequency if re-selection criteria are fulfilled; and/or the WTRU shall exclude the barred cell as a candidate for cell selection/reselection for 300 seconds.

If a WTRU is unable to acquire the MIB, the WTRU may consider the cell as barred and perform barring as if intraFreqReselection is set to allowed as per current standard operation, including the WTRU may exclude the barred cell as a candidate for cell selection/reselection for up to 300 seconds, and/or the WTRU may select another cell on the same frequency if the selection criteria are fulfilled.

For RRC connected WTRUs, beam switching/recovery and mobility management is performed on the latest SSB the WTRU retrieves the MIB and SIB1 system information from. In addition, the network can dynamically signal the RRC connected WTRUs to switch the SSB frequency location via dedicated RRC signaling. The absoluteFrequencySSB in the FrequencyInfoDL IE can be used to indicate the new SSB frequency location to the WTRU. Different signaling approaches such as MAC-CE may also be considered to signal the SSB frequency switching.

In some examples, transmission-based high-power narrowband interference may occur in multiple cell-defining blocks. In examples, two or more cell defining SSB locations may be allocated that are far apart in the carrier band. Therefore, if one of the cell defining SSB is corrupted by the high-power narrowband interferer, the other one is not likely affected.

Some examples perform gradual reduction in transmit power levels in the affected SSB beam indices. The aim is to force the WTRUs to select the other beams. The beams can be selected from the same or a neighboring cell. In some examples, a node, which can be a network node or in some embodiments an external node to the network, determines interferer characteristics such as carrier frequency, bandwidth, periodicity, dwell time, AoA, and PSD. These measurements may be determined within the wireless network by internal nodes, WTRU or other devices obtaining and/or observing those measurements relevant to both WTRUs and the gNBs.

In examples, detection of the PSD level passing a predefined threshold triggers an event. Upon the event being triggered, the network, or a node or component thereof identifies affected SSB indices and starts gradually reducing the transmit power levels. In some embodiments upon the accumulated power exceeding a predefined threshold, the network reflects the changed SSB power level in the SIB1 and sends a SI update message to all WTRUs.

Once the interferer is no longer present, e.g., as detected or indicated by a node detector, the network may take actions to restore or return to pre-event or original power settings. In some examples, a method includes dynamically changing SS/PBCH location in time by either shifting the half frame timing or the SSB periodicity or combining both approaches to avoid the time overlapping of the SSB and interference transmissions. For example, a node (which can be an external node to the network) determines the interferer characteristics such as carrier frequency, bandwidth, periodicity, dwell time, AoA, and PSD. These measurements can also be determined within the wireless network by observing the measurements relevant to both WTRUs and the gNBs. The determined PSD level passing a predefined threshold is defined as an event. The occurrence of this event triggers responsive actions by the network.

Upon detection of the occurrence of this event, the network (or one or more nodes or components thereof) may act to shift the half frame timing and sets the bit field in the MIB accordingly to avoid the interferer in time domain. In some examples, the network (or one or more nodes or components thereof) changes SSB burst periodicity with or without half frame timing shift to avoid interferer in time domain. In some examples, the network (or one or more components thereof) may act to increase the beam failure detection timing so that WTRUs are not adversely affected by the introduced timing changes.

In some examples, an interferer presence indicator is used to indicate the occurrence of a condition or event signifying interferer presence. Detecting the indicator set to signify interferer presence triggers activation of time-frequency collision-avoidance procedures. When the interference is no longer present, as can be indicated by the presence indicator setting, the network adjusts operational parameters and settings for the WTRUs to reestablish themselves in synchronization, initial access, and beam selection. This can be done for example by increasing the SSB periodicity and related RACH occasion numbers within a predefined transition period and increasing relevant beam transmit power. The cellular network may default back to the original deployment scenario parameter settings after the transition period ends while the interferer is no longer present or its effects are negligible. Alternatively, the cellular network may maintain the mitigated deployment scenario indefinitely.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a base station, the method comprising:
detecting interference based on a presence of an interferer;
determining a power spectral density (PSD) level from the detected interference;
based on the PSD level exceeding a threshold, determining a synchronization signal burst (SSB) frequency location that mitigates the detected interference; and
transmitting a signal in the determined SSB frequency location to at least one wireless transmit receive unit (WTRU) being served by the base station.

2. The method of claim 1, wherein the interferer is RADAR.

3. The method of claim 1, wherein the detecting interference includes determining interference characteristics of the interferer.

4. The method of claim 3, further comprising:
comparing the determined interference characteristics of the interferer and a bandwidth of an existing SSB block frequency location.

5. The method of claim 1, wherein the detecting comprises measuring channel conditions including at least one of a carrier frequency, a bandwidth, a periodicity, a dwell time, and an angle of arrival (AoA).

6. The method of claim 1, wherein the detecting comprises receiving a channel condition measurement from at least one of a WTRU and a gNB within a network.

7. The method of claim 1, wherein the threshold is based on a level beyond which interference affects operation of the base station.

8. The method of claim 1, wherein the determined SSB frequency is a lower frequency than a previous SSB frequency.

9. The method of claim 1, further comprising:
after a preset period of time, reverting the determined SSB frequency location back to an original SSB frequency location.

10. The method of claim 1, further comprising:
when the detected interference dissipates, reverting the determined SSB frequency location back to an original SSB frequency location.

11. A base station comprising:
a processor; and
a transceiver communicatively coupled to the processor, the processor and transceiver cooperatively operating to:
detect interference based on a presence of an interferer;
determine a power spectral density (PSD) level from the detected interference;
based on the PSD level exceeding a threshold, determine a synchronization signal burst (SSB) frequency location that mitigates the detected interference; and
transmit a signal in the determined SSB frequency location to at least one wireless transmit receive unit (WTRU) being served by the base station.

12. The base station of claim 11, wherein the interferer is RADAR.

13. The base station of claim 11, wherein the processor and transceiver operate to determine interference characteristics of the interferer.

14. The base station of claim 13, the processor and transceiver further comprising to operate to compare the determined interference characteristics of the interferer and a bandwidth of an existing SSB block frequency location.

15. The base station of claim 11, wherein the detecting comprises measuring channel conditions including at least one of a carrier frequency, a bandwidth, a periodicity, a dwell time, and an angle of arrival (AoA).

16. The base station of claim 11, wherein the detecting comprises receiving a channel condition measurement from at least one of a WTRU and a gNB within a network.

17. The base station of claim 11, wherein the threshold is based on a level beyond which interference affects operation of the base station.

18. The base station of claim 11, wherein the determined SSB frequency is a lower frequency than a previous SSB frequency.

19. The base station of claim 11, further comprising, after a preset period of time, the processor and transceiver operating to revert the determined SSB frequency location back to an original SSB frequency location.

20. The base station of claim 11, further comprising, when the detected interference dissipates, the processor and transceiver operating to revert the original SSB frequency location back to an original SSB frequency location.
